(19) United States
(12) Patent Application Publication
(10) Pub. No.: US 2014/0054096 A1
(43) Pub. Date: Feb. 27, 2014

(54) APPARATUS CAPABLE OF MEASURING LOAD AND LOAD MOVEMENT

(71) Applicants: David Carruthers, Edinburgh (GB); Gary Kenneth Morby, Brussels (BE)

(72) Inventors: David Carruthers, Edinburgh (GB); Gary Kenneth Morby, Brussels (BE)

(21) Appl. No.: 14/060,246

(22) Filed: Oct. 22, 2013

Related U.S. Application Data
(63) Continuation of application No. 13/879,239.

(30) Foreign Application Priority Data
Oct. 12, 2010 (GB) 1017169.2

(51) Int. Cl. G01G 23/36

(52) U.S. Cl. CPC G01G 23/36
USPC 177/45; 177/50

(57) ABSTRACT

There is herein described apparatus capable of measuring load and load movement. More particularly, there is described apparatus capable of measuring both load and load movement using at least one sensor located between an upper and lower floor structure.

### CROSS-REFERENCE TO RELATED APPLICATIONS

This application is a continuation under 35 U.S.C. §120 of U.S. patent application Ser. No. 13/879,239 filed Apr. 12, 2013 in the names of David Carruthers and Gary Kenneth Morby, which was filed under the provisions of 35 U.S.C. §371 as a U.S. national phase application of International Patent Application No. PCT/GB11/51949 filed Oct. 11, 2011, which in turn claims priority of Great Britain Patent Application No. 1017169.2 filed Oct. 12, 2010. The disclosures of such U.S. patent application, international patent application and Great Britain priority patent applications are hereby incorporated herein by reference in their respective entireties, for all purposes.

### FIELD OF THE INVENTION

The present invention relates to apparatus capable of measuring load and load movement. More particularly, the present invention relates to apparatus capable of measuring both load and load movement using at least one sensor located between an upper and lower floor structure.

### BACKGROUND OF THE INVENTION

There is a problem in carrying loads in that it is sometimes unknown as to the load being carried. For example, using commercial lifts it is unknown what the load is before it is laid on a vehicle for transport. This is a common problem in supermarkets where commercial lifts are unable to measure and monitor loads before they are lifted onto vehicles (e.g. trucks) for transport. This can lead to trucks being inadvertently overloaded and therefore being driven under dangerous conditions.

A further problem exists using containers such as in the shipping industry. Containers can be overloaded if their weight is not known. This problem is also addressed by the present invention.

It is an object of at least one aspect of the present invention to obviate or mitigate at least one or more of the aforementioned problems.

It is a further object of at least one aspect of the present invention to provide apparatus capable of measuring both load and load movement.

It is a further object of at least one aspect of the present invention to provide a method of measuring both load and load movement.

### BRIEF DESCRIPTION OF THE DRAWINGS

Embodiments of the present invention will now be described, by way of example only, with reference to the accompanying in which:

FIG. 1 is a view of a sensor according to an embodiment of the present invention;

FIG. 2 is a sectional side view of a sensor located between an upper and lower floor structure according to an embodiment of the present invention; and

FIG. 3 is a schematic block representation of an apparatus comprising a sensor according to an embodiment of the present invention.

### SUMMARY OF THE INVENTION

According to a first aspect of the present invention there is provided apparatus capable of measuring both load and load movement, said apparatus comprising:
at least one sensor capable of measuring a load;
the at least one sensor located between an upper and lower floor structure;
a display unit;
wherein the at least one sensor is capable of measuring the load and/or changes in the load to detect load movement and thereafter display the measured load on the display unit.

The present invention therefore relates to apparatus capable of measuring loads and load movement. The loads may therefore be measured during a static or movable environment.

Typically, the sensor may be capable of measuring a load with a high degree of accuracy such as to within a few ounces or grams.

The apparatus may comprise any suitable number of sensors which may be connected to one another in series and/or parallel. For example, there may be plurality of sensors capable of measuring a load exerted from above. Typically, the number of sensors may be chosen to provide an accurate determination of the load being applied to a load bearing surface.

In particular embodiments the sensors may be over-moulded with, for example, plastics material and inserted between upper and lower layers of a floor structure. The sensors may be secured in place using any suitable adhesive and/or mechanical means.

The upper and lower floor structure may therefore form a continuous planar structure above and below the at least one sensor. The upper and lower floor structure may therefore form a sandwich-type structure with the at least one sensor located between the upper and lower layers.

The upper and lower layers may be formed from any suitable material such as any one or combination of the following: metal plates such as, for
example, made from steel or aluminum; wood or wood based materials; plastics; or carbon fibre composite. For high weight, a strong material is chosen for the upper and lower layers so that there is no deformation in the layers as force is exerted thereupon. In particular embodiments, the size of the upper and lower floor area may extend over the load bearing area. This allows an accurate weight to be determined.

The at least one sensor may be connected to a multiplexor using cables or wirelessly. The multiplexor may then transmit a signal to a processing unit once again either via a cable or wirelessly. The processing unit may process the received information using any suitable software and then display the information on a display unit. The information may be transmitted from the processing unit to the display unit using a cable or wirelessly. Once the display unit receives the transmitted signal, then this may be displayed on the display unit. For example, the display unit may display the measured weight in pounds and ounces or kilograms or grams.

In addition, the display unit may also comprise audible means so that an audible alert signal may be emitted when either excessive loads are being measured or the transmitted load is detected to be moving. Usually, a change in the load being measured indicates that the load is unstable and is moving. Therefore, in the event that the load changes by a few percent during transit, then an audible and/or visual signal such as a flashing light or siren may be used.

The display unit may also comprise a system of lights (e.g. green meaning an acceptable weight and no load movement, amber meaning borderline weight
and some load movement being detected and red meaning an over-weight load or a load that is being detected as moving).

As indicated above, any suitable type of display unit may be used. However, in particular embodiments the display unit may be a mobile phone with a wireless or bluetooth connection. There may also be the option for information received by the display unit to be forwarded to any point in a country by means of a global positioning system (i.e. GPS) connection.

According to a second aspect of the present invention there is provided a method of measuring both load and load movement, said method providing:
at least one sensor capable of measuring a load;
the at least one sensor located between an upper and lower floor structure;
a display unit;
wherein the at least one sensor is capable of measuring the load and/or changes in the load to detect load movement and thereafter display the measured load on the display unit.

### BRIEF DESCRIPTION

Generally speaking the present invention resides in the provision of apparatus capable of measuring both load and load movement.

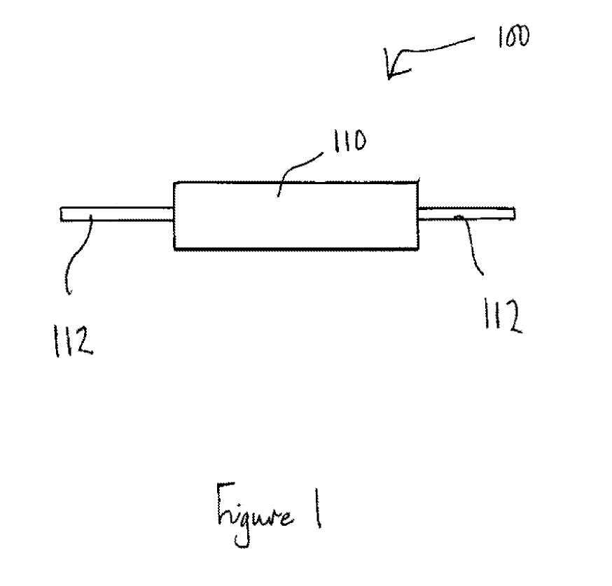

FIG. 1 represents a sensor generally represented 100 according to the present invention. The sensor 100 comprises a main body 110 which is capable of measuring vertical load exerted on its upper surface and ends 112 which may be connected to other sensors.

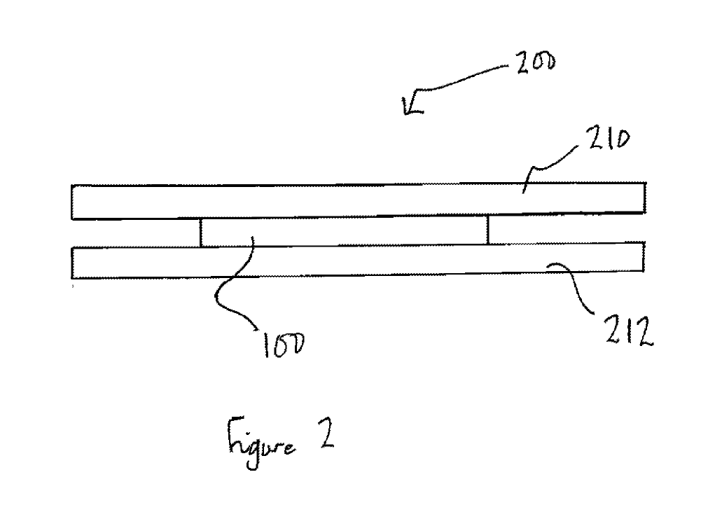

As shown in FIG. 2, there is a representation of a sensor 100 in use generally designated 200. The sensor 100 is located between an upper and lower floor structure, 210, 212, respectively. The sensor 214 is therefore sandwiched between the upper and lower floors 210, 212 and may be secured by any suitable type of adhesive or mechanical means. Any suitable type of sensor 100 may be used that is capable of measuring load exerted on it.

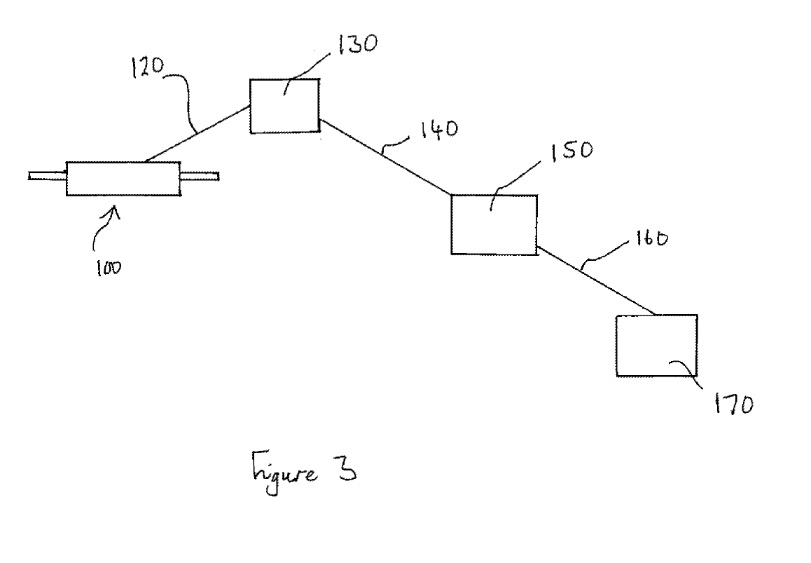

FIG. 3 is a representation of the sensor 100 in use. The sensor 100 sends a signal along cable 120 to a multiplexor 130. The multiplexor 130 then sends a signal along cable 140 to a processing unit 150 whereupon the processed signal is then sent along cable 160 and is then displayed on a display unit 170. It should be noted that although the signal is sent along cables shown in FIG. 3 a wireless communication may also be used.

The processor unit 150 may comprise any suitable processing means such as software embedded into a main processing circuit which may, for example, be a GPS processor. The display unit 170 may be mounted on any suitable location. The displayed information may be displayed in any suitable form and may be displayed in a load indication form using a system of lights (e.g. green meaning an acceptable weight and no load movement, amber meaning borderline weight and some load movement being detected and red meaning an over-weight load or a load that is being detected as moving). Alternatively, the displayed information may be displayed in a format which enables the weight to be displayed in pounds and ounces or kilograms and grams. In addition, the display unit may also comprise an audible warning to indicate when excessive loads or a moving load is detected. In the event that excessive loads or moving loads are detected, the display unit may use any combination of alerting means such as audible and/or visual warnings.

The display unit 170 may either be a purpose made display unit or may be a display in a standard mobile smart phone that has a suitable wireless or Bluetooth connection. The phone may display the signal from the processing unit 150 after a software update has been installed in the mobile phone. As a signal is sent to the display unit 170, there may be an option for the signal to be dispatched by GPS to a suitable receiving unit.

Whilst specific embodiments of the present invention have been described above, it will be appreciated that departures from the described embodiments you still fall within the scope of the present invention. For example, any suitable type of sensor may be used. Moreover, any suitable type of upper and lower floor structure may be used.

1. Apparatus capable of measuring both load and load movement, said apparatus comprising:
at least one sensor capable of measuring a load;
the at least one sensor located between an upper and lower floor structure;
a display unit;
wherein the at least one sensor is capable of measuring the load and changes in the load to detect load movement and thereafter display the measured load on the display unit.

2. Apparatus capable of measuring both load and load movement according to claim 1, wherein the loads are being moved from one location to another or are stationary.

3. Apparatus capable of measuring both load and load movement according to claim 1, wherein the at least one sensor is capable of measuring a load to within a few ounces or grams.

4. Apparatus capable of measuring both load and load movement according to claim 1, wherein the apparatus comprises a plurality of sensors which are capable of being connected to one another in series and/or parallel.

5. Apparatus capable of measuring both load and load movement according to claim 1, wherein the sensors are over-molded and inserted between upper and lower layers of a floor structure.

6. Apparatus capable of measuring both load and load movement according to claim 1, wherein the sensors are secured in place using any suitable adhesive and/or mechanical means.

7. Apparatus capable of measuring both load and load movement according to claim 1, wherein the upper and lower floor structure form a continuous planar structure above and below the at least one sensor.

8. Apparatus capable of measuring both load and load movement according to claim 1, wherein the upper and lower floor structure form a sandwich-type structure with the at least one sensor located between the upper and lower layers.

9. Apparatus capable of measuring both load and load movement according to claim 1, wherein the upper and lower layers are formed from any one or combination of the following: metal plates wood or wood based materials; plastics; or carbon fibre composite.

10. Apparatus capable of measuring both load and load movement according to claim 1, wherein the size of the upper and lower floor area extends over the load carrying area.

11. Apparatus capable of measuring both load and load movement according to claim 1, wherein the at least one sensor is connected to a multiplexor using cables or wirelessly whereupon the multiplexor then transmits a signal to a processing unit once again either via a cable or wirelessly.

12. Apparatus capable of measuring both load and load movement according to claim 11, wherein the processing unit processes the received information using any suitable software and then displays the information on a display unit and the information is then transmitted from the processing unit to the display unit using a cable or wirelessly where information is then displayed on the display unit.

13. Apparatus capable of measuring both load and load movement according to claim 1, wherein the display unit also comprises audible means so that an audible alert signal is capable of being emitted when either excessive loads are being carried or the transmitted load is detected to be moving.

14. Apparatus capable of measuring both load and load movement according to claim 1, wherein the display unit also comprises a system of lights.

15. Apparatus capable of measuring both load and load movement according to claim 1, wherein the display unit is a mobile phone with a wireless or bluetooth connection.

16. Apparatus capable of measuring both load and load movement according to claim 1, wherein the display unit is capable of forwarding information to any point in a country by means of a global positioning system (GPS) connection.

17. Apparatus capable of measuring both load and load movement according to claim 5, wherein the sensors are over-molded with plastics material.

18. Apparatus capable of measuring both load and load movement according to claim 9, wherein the metal is steel or aluminum.

19. Apparatus capable of measuring both load and load movement according to claim 14, wherein the system of lights includes a green light, meaning an acceptable weight and no load movement, an amber light, meaning borderline weight and some load movement being detected, and a red light, meaning an over-weight load or a load that is being detected as moving.
